(19) United States
(12) Patent Application Publication
(10) Pub. No.: US 2013/0114642 A1
(43) Pub. Date: May 9, 2013

(54) TEMPERATURE RECORDER COMPRISING A LIQUID CRYSTALLINE MATERIAL

(71) Applicants: Helen Gleeson, Greater Manchester (GB); Ingo Dierking, Greater Manchester (GB); Paul Brimicombe, Greater Manchester (GB); Sarabjot Kaur, Greater Manchester (GB); Bruce Donald Grieve, Greater Manchester (GB); Neville Christopher Paul Woodyatt, Greater Manchester (GB); Jaroslaw Muriusz Wasikiewicz, Greater Manchester (GB); Stephen George Yeates, Greater Manchester (GB); Michael Lewis Turner, Greater Manchester (GB)

(72) Inventors: Helen Gleeson, Greater Manchester (GB); Ingo Dierking, Greater Manchester (GB); Paul Brimicombe, Greater Manchester (GB); Sarabjot Kaur, Greater Manchester (GB); Bruce Donald Grieve, Greater Manchester (GB); Neville Christopher Paul Woodyatt, Greater Manchester (GB); Jaroslaw Muriusz Wasikiewicz, Greater Manchester (GB); Stephen George Yeates, Greater Manchester (GB); Michael Lewis Turner, Greater Manchester (GB)

(73) Assignee: SYNGENTA LIMITED, Guildford, Surrey (GB)

(21) Appl. No.: 13/810,204

(22) PCT Filed: Jul. 7, 2011
(86) PCT No.: PCT/EP2011/061516

§ 371 Date: Jan. 14, 2013

(30) Foreign Application Priority Data
Jul. 14, 2010 (GB) 1011818.0

(51) Int. Cl. G01K 1/02

(52) U.S. Cl. 374/186

(57) ABSTRACT

A temperature recorder comprises a sensing cell which comprises a reactant mixture. The reactant mixture comprises a liquid crystalline material, a reactive monomer, and an initiator configured to initiate cross-linking of the reactive monomer and thereby form a sensing material which provides a record of the temperature of the sensing cell when cross-linking occurs. The sensing material comprises a cross-linked network dispersed within the liquid crystalline material, the cross-linked network being formed from the reactive monomer. The sensing cell additionally comprises first and second electrically conductive electrodes having a spaced relationship there between and being connectable to an electric property measuring device arranged to measure an electric property of the sensing material.

The present invention relates to a temperature recorder and to a method of temperature recording.

Temperature sensors have many diverse applications in common use. It is known to use liquid crystals as part of temperature sensors which can be read optically. One such example are “digital” strip thermometers which are commonly available. The use of liquid crystals as a temperature sensor, for example a thermometer, may be advantageous in that they are cheaper to manufacture than other types of temperature sensor, such as fluid based thermometers. Furthermore, fluid expansion based thermometers tend to be considerably more fragile than liquid crystal thermometers. Most applications utilising liquid crystals require that the liquid crystals are aligned in order that they function as desired.

Optical liquid crystal thermometers would be complex and relatively costly to integrate within an electronic system. One reason for this is that it would be necessary to provide both a light source and an optical sensor means to detect any change in the state of the liquid crystal in response to temperature. The optical sensor would then need to produce an output which could form part of an electrical system.

It is known for an electronic temperature sensor, such as a thermistor, to form part of an electronic temperature recording system. Within such a system, it is known for an electronic memory to be used to record the output of the electronic temperature sensor at a particular moment in time. The provision of an electronic memory within an electronic temperature recording system may make the electronic temperature recording system complicated and costly to manufacture. In known electronic temperature recording systems, electrical power must be supplied to the electronic temperature sensor when the output of the electronic temperature sensor is to be recorded. Furthermore, the use of an electronic memory may require that the electronic memory is powered at least when the output of the electronic temperature sensor is recorded. Some known electronic memories require a constant power supply. It follows that known electronic temperature recording systems may have substantial power requirements. The provision of a power source to meet these power requirements may lead to an increase in size, complexity and cost of such an electronic temperature recording system.

It is an object of the present invention to overcome or mitigate at least one of the above disadvantages.

According to a first aspect of the invention there is provided a temperature recorder comprising a sensing cell which comprises a reactant mixture, the reactant mixture comprising a liquid crystalline material, a reactive monomer, and an initiator configured to initiate cross-linking of the reactive monomer and thereby form a sensing material which provides a record of the temperature of the sensing cell when cross-linking occurs; the sensing material comprising a cross-linked network dispersed within the liquid crystalline material, the cross-linked network being formed from the reactive monomer; wherein the sensing cell additionally comprises first and second electrically conductive electrodes having a spaced relationship therebetween and being connectable to an electric property measuring device arranged to measure an electric property of the sensing material.

Hence, the apparatus can be used as a temperature recorder which records a temperature at a given time. The given time is that at which cross-linking occurs. The apparatus may be easily integrated into an electronic system and the sensing temperature need not be close to a phase transition temperature of the liquid crystal material. The electric property measuring device may not be connected to the sensing cell at the time of cross-linking. It follows that the temperature sensor does not require a source of electrical power in order to record the temperature at the given time.

The liquid crystalline material may be polar. This polar liquid crystalline material may be a ferroelectric or ferrielectric material.

The sensing material may comprise a continuous phase of liquid crystalline material and the cross-linked network may form a distributed network amongst the liquid crystalline material.

The first and second electrically conductive electrodes may be configured to produce an electric field within the sensing material when connected to an electric property measuring device.

The electric property measuring device may be a capacitance measuring device arranged to measure the capacitance of the sensing cell. The capacitance measuring device may be configured to produce an oscillating electric measuring signal. The measuring signal may have a frequency of less than about 5000 Hz. The capacitance measuring device may be configured to measure the RC time constant for electrically charging and/or discharging the sensing cell.

The electrical property measuring device comprises a temperature measuring device configured to measure the temperature of the environment in which the electrical property measuring device is operating. The electrical property measuring device may be configured to provide an output which is a function of both the measured electric property of the sensing cell and the temperature of the environment in which the electrical property measuring device is operating.

The initiator may comprise a chemical component within the reactant mixture and further comprises an energy source. The chemical component may comprise a photo initiator and the energy source may be a radiation source.

The initiator may be triggered by a substance which is present in air. Alternatively, the initiator may be triggered by an electrical pulse. Other examples of sources of initiation include moisture, oxygen, heat and radiation, e.g. UV, light.

The temperature recorder may comprise a plurality of similar independent sensing cells, the initiation of cross-linking in each sensing cell to form a sensing material being independent of another sensing cell. Hence the temperature recorder may record temperature at a plurality of times, each independent sensing cell recording temperature at a separate time.

According to a second aspect of the present invention there is provided a method of recording temperature at a first time using a temperature recorder according to the first aspect of the invention, the method comprising: cross-linking the reactive monomer at the first time to thereby form the sensing material, the cross-linking being initiated by triggering the initiator; measuring the electric property of the sensing material with an electrical property measuring device connected to the first and second electrodes at a second time, the second time being after the first time; and providing an output which is representative of the temperature of the sensing cell at the first time.

The temperature recording method may additionally comprise: using a temperature measuring device to measure the temperature of the environment in which the electrical property measuring device is operating at the second time; and correcting the output as a function of the measured temperature of the environment in which the electrical property measuring device is operating.

According to a third aspect of the invention there is provided a temperature recorder comprising a sensing cell which comprises a sensing material which is produced by: mixing a liquid crystalline material and a reactive monomer; and initiating cross-linking of the reactive monomer, to thereby form a cross-linked network dispersed within the liquid crystalline material, the cross-linked network being formed from the reactive monomer.

Other preferred and advantageous features of the various aspects of the present invention will be apparent from the following description.

Specific embodiments of the present invention will now be described, by way of example only, with reference to the accompanying drawings, in which:

FIG. 1 is a graph showing the capacitance of a prior art liquid crystalline material as a function of temperature;

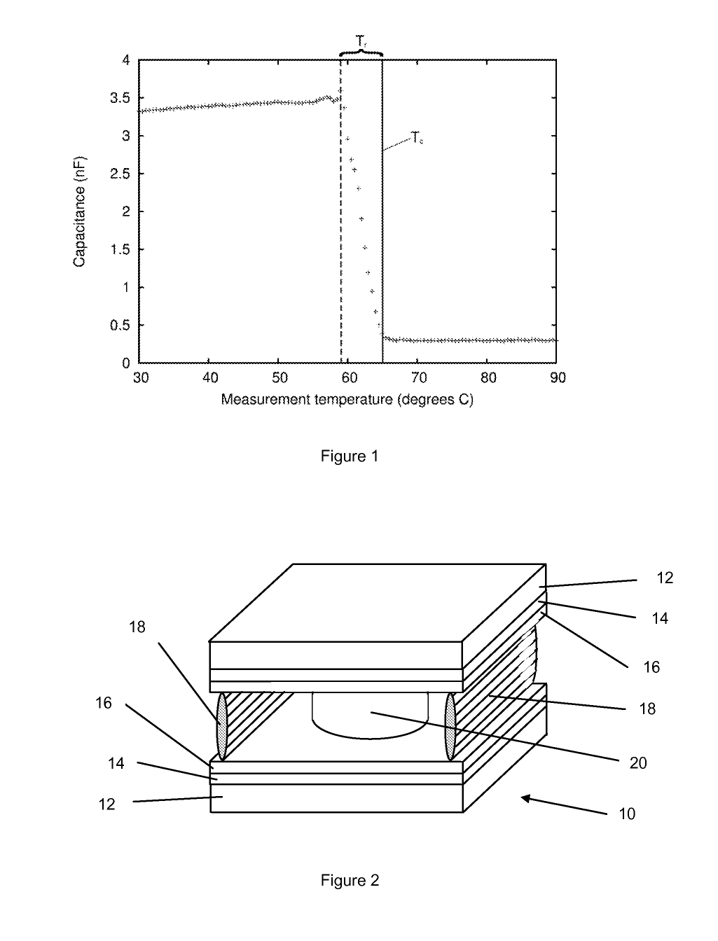

FIG. 2 is a perspective, schematic view of a temperature sensing cell in accordance with an embodiment of the present invention;

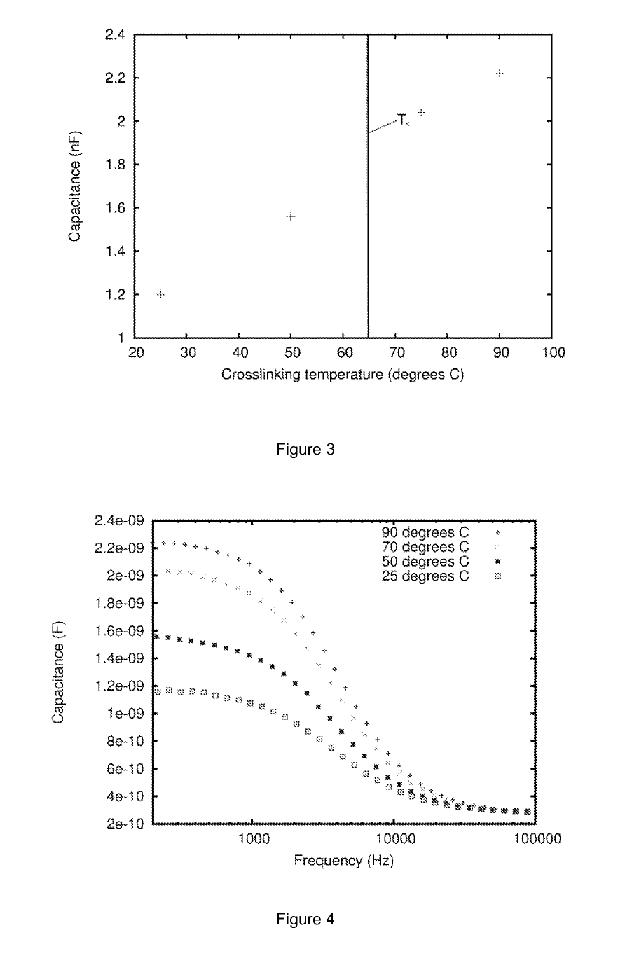

FIG. 3 is a graph showing the response of a temperature recorder according to an embodiment of the present invention as a function of the temperature at which a cross-linking process of a reactant monomer is initiated;

FIG. 4 is a graph showing the variation in measured capacitance of a temperature recorder according to the present invention as a function of both the temperature at which the cross-linking process of a reactant monomer is initiated and as a function of the frequency of signal used to measure the capacitance of the temperature recorder; and

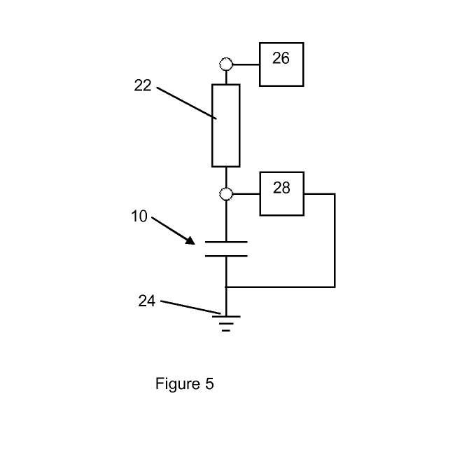

FIG. 5 is a schematic diagram of a circuit which may form part of an electrical property measuring device which may form part of an embodiment of the invention.

It is known that some liquid crystalline materials exhibit a change in their electrical properties which is dependent upon temperature.

A liquid crystalline material, at a particular temperature, exists in either a polar state or a non-polar state. In a polar state, a liquid crystalline material has a net polarisation. The net polarisation may be caused by the relative alignment of dipolar liquid crystals within the liquid crystalline material. Examples of materials which exist in a polar state (referred to as polar liquid crystalline materials) include ferroelectric and ferrielectric materials.

The most common liquid crystal phase that can exhibit ferroelectricity is the chiral Smectic C (Sm C*) phase, in which the liquid crystal molecules exist in layers. Each molecule is angled relative to the layer normal at a fixed tilt angle. Successive layers show a gradual change in the azimuthal direction of tilt (although the tilt angle remains constant), such that the molecule precesses about the layer normal from layer to layer, on the surface of an imaginary cone. It follows that the liquid crystal molecules exhibit precession around a helix as you move through the liquid crystalline material in a direction parallel to the normal of the layers. Because of this, the spontaneous polarisation of the liquid crystalline material also precesses around a helix as you move through the liquid crystalline material in a direction parallel to the normal of the layers. This is known as a helielectric phase. At a macroscopic level the net polarisation of the liquid crystalline material may be considered to be zero due to the helical change in polarisation between layers. However, in a thin film geometry of liquid crystalline material (which may be used by embodiments of the invention) surface interactions may cause the helix to be partially or fully unwound. A liquid crystalline material may be referred to as having a thin film geometry if it has a thickness of for example between about 1 and 50 μm. It may also be the case that in a thin film geometry of liquid crystalline material the number of layers within the liquid crystalline material is less than the number of layers required for a complete helix cycle. This may also lead to the macroscopic helix of a thin film geometry liquid crystalline material being referred to as unwound. Where a liquid crystalline material has a macroscopic helix which is unwound, the liquid crystalline material will have a net polarisation and will hence exhibit ferroelectric behaviour. Such thin film geometry liquid crystalline materials may be referred to as surface-stabilized ferroelectric liquid crystals or SSFLCs. Other known liquid crystal phases which are capable of exhibiting ferroelectric properties include chiral Smectic I (Sm I*) and chiral Smectic F (Sm F*).

A known ferrielectric liquid crystal phase is the intermediate three-layer phase, also known as the Smectic C* FI1 phase.

Ferroelectric and ferrielectric materials possess a spontaneous electric polarisation that can be reversed by the application of an external electric field. In a ferroelectric phase in which the macroscopic helix is unwound as discussed above, the dipoles within the liquid crystalline material are substantially aligned in the same direction, whereas, in a ferrielectric phase, this is not the case. This results in ferrielectric liquid crystalline materials having a net polarisation at a macroscopic level which has a magnitude that is less than an equivalent ferroelectric phase. It should be noted that it is possible for a single liquid crystalline material to have both ferroelectric and ferrielectric phases depending on its temperature.

Ferroelectric and ferrielectric materials may undergo a phase change between a polar state and a non-polar state as a result of a change of temperature.

The non-polar state may be a non-ferroelectric phase or a non-ferrielectric phase. Examples of non-ferroelectric phases include Smectic A, Nematic, isotropic, and anti-ferroelectric.

The anti-ferroelectric phase (for example the anti-ferroelectric chiral Smectic C (SmC*_{A}) phase) is considered to be a non-polar state in a thin film geometry. This is because, although individual layers of the liquid crystal in the SmC*_{A} phase are polarised, the thin film geometry means there will be many adjacent layers in which the spontaneous polarisation orientation alternates resulting in no net polarisation.

As the temperature of known liquid crystalline materials changes, the phase of the liquid crystalline material may change which may result in a change in the state of the liquid crystalline material. A temperature at which a liquid crystalline material changes between a first and a second phase is known as a phase transition temperature. A change in temperature of the liquid crystalline material which spans a phase transition temperature may cause the liquid crystalline material to switch between a first state and a second state. The phase transition temperature between two phases is also governed by the ambient pressure. The ingress of contaminants, including gases, liquids and solids, into the liquid crystalline material may also affect the phase transition temperature.

The graph shown in FIG. 1 shows the measured capacitance of a liquid crystalline material (KC-FLC10, obtained from Kingston Chemicals, Hull, UK) as a function of temperature. Measurements were taken using an Agilent E4980A impedance analyser using an oscillating measurement signal with a frequency of 20 Hz and a voltage of 50 mV_{RMS}. The liquid crystalline material was a 5 micron thickness film, aligned using a rubbed polyimide alignment layer. It can be seen within the graph shown in FIG. 1 that the response of the liquid crystalline material is such that it is fairly constant with respect to temperature until it reaches approximately 59° C. At this point, there is a step-like decrease in measured capacitance. Beyond approximately 65° C. the capacitance of a liquid crystalline material again remains substantially constant.

The transition temperature T_{c} between the polar, ferroelectric, chiral smectic C (Sm C*) and the non-polar, non-ferroelectric, smectic A (Sm A) phase which occurs at 65° C. in the case of the liquid crystalline material KC-FLC10 is shown on the graph in FIG. 1. The liquid crystalline material is in the Sm C* phase below T_{c} and in the Sm A phase above T_{c}.

It can be seen that the step change in the capacitance of the liquid crystalline material occurs at the transition temperature T_{c} between the Sm C* and Sm A phases. Because the capacitance of the liquid crystalline material does not change significantly at temperatures which are away from the transition temperature T_{c}, it is difficult to use measurements of the capacitance of such a liquid crystalline material to measure temperatures which are away from the phase transition temperature T_{c}. Due to the fact that the change in measured capacitance of the liquid crystalline material as a function of temperature is very small at temperatures away from the transition temperature T_{c}, the resolution of any such temperature measurement will be dependent on the sensitivity of the capacitance measuring device used. It follows that in order to measure temperatures away from the transition temperature with a reasonable resolution, the sensitivity of the capacitance measuring device would have to be relatively high. A capacitance measuring device with a resolution high enough to measure such changes in capacitance may be very difficult to produce or may be prohibitively expensive. It follows that measuring the capacitance of the liquid crystalline material in order to sense the temperature of the liquid crystalline material is practically limited to the temperature region (indicated as Tᵣ between dashed lines) surrounding the phase transition temperature T_{c}.

Due to the step change in the measured capacitance of the liquid crystalline material at T_{c}, it is only possible to measure the temperature at a relatively high resolution when the temperature to be measured is near to the phase transition temperature T_{c}. As a result of this, in order to measure a particular temperature with a relatively high degree of resolution, it may be necessary to choose the liquid crystalline material so that its phase transition temperature T_{c} is similar to that particular temperature. Liquid crystalline materials with polar to non-polar phase transition temperatures T_{c} which are below 50° C. may be difficult to obtain, thus making the use of the above described system to measure temperatures below 50° C. unfeasible. Furthermore, as previously discussed, if it is desired to measure temperatures at relatively high resolution over a wide range of temperatures (i.e. over a range of temperatures which extends beyond the temperature region Tᵣ of a particular liquid crystalline material) then this may also be unfeasible.

FIG. 2 shows a sensing cell 10 in accordance with an embodiment of the present invention. The sensing cell 10 comprises two glass substrates 12. Each substrate 12 has an electrically conductive electrode 14 upon which there is an alignment layer 16. The substrates 12 are arranged such that their alignment layers 16 face each other and such that they are spaced apart by spacers 18. The spacers 18 ensure that the separation between the alignment layers 16 (and hence the electrodes 14 and glass substrates 12) is controlled. The separation distance between the electrodes 14 is a factor which determines the strength of the electric field between the electrodes when a voltage is applied across the electrodes 14. A sensing material 20 is sandwiched between the alignment layers 16. The electrode 14 may be any suitable electrically conductive material. One example is indium-tin oxide (ITO).

The alignment layer 16 is a uni-directionally rubbed polyimide layer which helps to align the liquid crystals within the liquid crystal material parallel to the rubbing direction. Other materials may be used to form an alignment layer, as is well known in the art. An example of such a material is rubbed polyvinyl alcohol.

The sensing material 20 is prepared by mixing a liquid crystalline material with a reactive monomer and an initiator to form a reactant mixture. In some cases, the proportion of the reactant mixture which is a liquid crystalline material may be approximately 95% to 99% by weight of the mixture, the proportion of the reactant mixture which is a reactive monomer may be approximately 1-5% of the weight of the mixture and the proportion of the reactant mixture which is the initiator may be approximately 2% by weight of the reactive monomer. Alternatively, the proportion of the reactant mixture which is liquid crystalline material may be approximately 40-99.5% by weight of the mixture, the proportion of the reactant mixture which is reactive monomer may be approximately 0.5-60% by weight of the mixture, and the proportion of the reactant mixture which is the initiator may be 0.1-50% by weight of the reactive monomer.

The reactant mixture is preferably a homogeneous mixture forming a liquid crystalline phase (as is the case in the example below). Alternatively, if the reactive monomer and/or initiator are not miscible with the liquid crystalline material, a dispersion of the former in the latter could be used.

An example of a suitable reactant mixture is 98.98% by weight of ferroelectric liquid crystal KC-FLC10, 1% by weight of a reactive monomer diacrylate RM-257 (available from Merck GmbH, Darmstadt, Germany) and 0.02% by weight of a photoinitiator benzoin methylether (BME) (available from Sigma Aldrich, Dorset, UK). The reactant mixture is heated to a temperature of approximately 100° C. (at which point the liquid crystalline material is in the non-polar chiral nematic phase) and is drawn into the sensing cell 10 by capillary action due to the spacing between the substrates 12. The sensing cell 10 and the incorporated reactant mixture is then cooled. In this case, the reactant mixture may be cooled such that the liquid crystalline material is in the Sm A or Sm C* phases, though the liquid crystalline material could be in other phases, for example the chiral nematic phase. For example, the sensing cell 10 (and reactant mixture) may be cooled to a temperature of less than 65° C., such that the liquid crystalline material is in the polar Sm C* phase.

The sensing cell 10 is now in a state in which it may be triggered in order to record its temperature. The recordal of the temperature is triggered by initiating a cross-linking process (for example a polymerisation reaction). In the current example, the initiator within the reactant mixture BME is a photo initiator which is sensitive to ultra-violet (UV) light. It follows that in order to initiate the cross-linking of the reactive monomer of the reactant mixture, it is necessary to expose the sensing material to UV radiation. In order to prevent premature cross-linking of the reactive monomer, the reactant mixture is screened from exposure to UV radiation before cross-linking. Exposure of the reactant mixture to UV radiation causes cross-linking of the reactive monomer to occur. This forms the sensing material 20. When cross-linking occurs, a cross-linked network phase separates from the liquid crystalline material. The crossed-linked network forms a distributed network which is distributed amongst the liquid crystalline material. The liquid crystalline material is in a continuous phase. In this context the term ‘continuous phase’ is intended to mean that it is possible to plot a continuous path through the liquid crystalline material from one point within the liquid crystalline material to substantially any other point within the liquid crystalline material.

The sensing material 20 comprises the combination of cross-linked network and the liquid crystalline material. Due to the sensing material 20 typically having a relatively low percentage by weight of cross-linked material, a network of this type is sometimes referred to as a sparse network.

At a given measurement temperature, the measured capacitance of the sensing material is dependent on the temperature at which the cross-linked network within the sensing material is created. It follows that a temperature sensor comprising a sensing material 20 according to the present invention is capable of ‘recording’ the temperature at which the creation of the cross-linked network occurred. Hence, a temperature sensor comprising a sensing material 20 according to the present invention is a temperature recorder.

FIG. 3 shows a graph of the relationship between measured capacitance of four similar sensing cells according to the present invention and the temperature at which the cross-linked network was formed in each case. The capacitance of each sensing cell was measured at 30° C. using an electrical property measuring device which was connected to the conductive electrodes 16. The electrical property measuring device applies a voltage across the sensing material 20 and thereby creates an electric field within the sensing material. In this case, the electrical property measuring device was an Agilent E4980A impedance analyser which used an oscillating measuring signal with a frequency of 20 Hz and a voltage of 50 mV_{RMS}.

Within the sensing cells used to produce FIG. 3, the sensing material was formed from a reactant mixture comprising KC-FLC10 98.98% by weight, RM-257 1% by weight and BME at 0.02% by weight. Due to the fact that BME is a UV photoinitiator it was possible to create the cross-linked network at different temperatures by heating each sensing cell (and hence each reactant mixture) to the desired temperature and then exposing it to UV light so as to initiate the cross-linking process and create the sensing material 20.

The graph shown in FIG. 3 shows that the measured capacitance of the sensing material increases with increasing temperature at which the cross-linked network is formed. Furthermore, the relationship between the measured capacitance and the cross-linking temperature is substantially linear. This linear relationship between cross-linking temperature and measured capacitance has two benefits: First, the cross-linking temperature dependence of the measured capacitance does not appear to be significantly affected by a phase change in the liquid crystalline material which formed part of the reactant mixture. This can be seen because there appears to be no anomaly or step-change in the relationship between capacitance and temperature around the phase transition temperature T_{c} of the liquid crystalline material which formed part of the reactant mixture. Secondly, there is a measurable change in the capacitance of the sensing material 20 formed at temperatures away from the transition temperature of the liquid crystalline material which formed part of the reactant mixture. It follows that the sensing material 20 may be used to record temperatures (at which cross linking of the sensing material occurs) which are away from the phase transition temperature of the liquid crystalline material which formed part of the reactant mixture. This may be in contrast to the ability of a liquid crystalline material on its own to measure temperature away from its phase transition temperature. FIG. 1 shows that the temperature dependence of the capacitance of a liquid crystalline material on its own. As previously discussed, it can be seen in FIG. 1 that a step change in the capacitance of the liquid crystalline material occurs at the transition temperature T_{c} between the Sm C* and Sm A phases. Because the capacitance of the liquid crystalline material does not change significantly at temperatures which are away from the transition temperature T_{c}, it is difficult to use measurements of the capacitance of the liquid crystalline material to measure temperatures which are away from the phase transition temperature T_{c}. Furthermore, because the relationship between measured capacitance and cross-linking temperature of the sensing material 20 is substantially linear (compared to the step change response of a liquid crystalline material on its own as shown in FIG. 1), the resolution to which the cross-linking temperature can be determined by measuring the capacitance is fairly constant across a wide range of temperatures. This in turn means that the sensitivity of a capacitance measuring device within the present invention may be lower than that required to measure the temperature dependant capacitance of known liquid crystalline materials (for example as shown in FIG. 1). The use of a less sensitive capacitance measuring device may reduce the cost of temperature recorders according to the present invention.

The ability of the sensing material 20 to record temperatures which are away from the transition temperature T_{c} of the liquid crystalline material with reasonable resolution may be beneficial. This is because it enables a wide range of liquid crystalline materials to be used as part of the sensing material 20 when it is desired to record temperature in a particular range. For example, if it desired to measure temperature in the range of say 10° C. to 20° C., using prior art liquid crystalline materials, a liquid crystal with a polar to non-polar phase transition temperature which is close to the desired temperature measurement range would need to be chosen (e.g. 15° C.). Such liquid crystalline materials may be costly or difficult to obtain. In contrast to this, using sensing material 20 according to the present invention to record a temperature, it is possible to utilise a liquid crystalline material within the sensing material 20 which has a polar to non-polar phase transition temperature T_{c} which is much greater (for example 70° C. to 100° C.) than the desired range. Liquid crystalline materials of this type may be easier to obtain than liquid crystalline materials with lower phase transition temperatures. Furthermore, because the transition temperature T_{c} of the liquid crystalline material used to form a reactant mixture of a temperature recorder according to the present invention does not have to be similar to the temperature to be recorded, a temperature recorder according to the present invention is capable of recording temperatures over a relatively large range. By relatively large range, it is meant that the range of temperatures which can be recorded by a temperature recorder according to the present invention is greater than the range of temperatures that can be measured by the liquid crystalline material which forms the reactant mixture of the temperature recorder.

Because a temperature recorder according to the present invention records the temperature of the sensing cell when cross-linking occurs, this property may be used to record a temperature at a particular time of interest. For example, a temperature recorder according to the present invention may be provided with a reactant mixture having an initiator such that the cross-linking of the reactive monomer can be initiated at a desired time. In the case of the reactant mixture described above, which comprises a photoinitiator, the temperature recorder may be provided with a UV source as part of the initiator. In this way, at the instant when it is desired to record the temperature of the sensing cell, the UV radiation source can be energised, thereby initiating the cross-linking process and recording the temperature of the sensing cell. It will be appreciated that in this embodiment the initiator comprises both a chemical component within the reactant mixture (BME) and an energy source (UV radiation) which co-operate to initiate cross-linking of the reactive monomer within the reactant mixture. Alternative embodiments of the present invention may use different types of initiator and, for example, may not require an energy source which is part of the temperature recorder. Examples of possible chemical components of the initiator include ionic cross-linkers and thermally or electrically produced free radicals. In some embodiments of the invention the reactive monomer may not require a separate initiator to initiate cross-linking. For example, cross linking of the reactive monomer may be triggered directly by an energy source—i.e. it is the reactive monomer itself which is the chemical component of initiator. It will be appreciated that the initiator may be any appropriate chemical component and/or energy source providing it is capable of initiating cross-linking of the reactive monomer. Depending on the type of chemical component of the initiator which is used, the recorder may also comprise a corresponding energy source. For example, the energy source may be a radiation source if the chemical portion of the initiator is a photoinitiator, or the energy source may be a source of electricity if the chemical component of the initiator is an electrically produced free radical. In some cases, the chemical component of the initiator may be such that the initiation is not provided by the temperature recorder itself, but rather by the environment of the temperature recorder in use. For example, initiation may be triggered by the presence within the environment of a particular substance (e.g. a substance present in the air such as moisture or oxygen) and the cross-linking of the reactive monomer may be caused by exposure of the reactant mixture to that substance.

In a further embodiment of the present invention, the temperature recorder may be provided with a series of similar sensing cells 10, each of which is isolated from the others and has its own reactant mixture and its own initiator. In this way, the initiator (and hence the cross-linking process) of each sensing cell 10 can be triggered at a different time. Therefore, the temperature recorder may record its temperature at several chosen times and hence produce a ‘history’ of the temperature it has been exposed to. One possible way of triggering the sensing cells individually in the case of using a photo initiator could be providing each sensing cell with its own UV light emitting diode (LED) and connecting each LED to an appropriate timing circuit.

In a temperature recorder comprising a plurality of sensing cells, each cell may be configured to cross-link at different time points by providing a different blend of reactive monomer in each cell. A reactive monomer is defined as one which is capable of undergoing polymerisation to form a polymer and/or cross-linked network upon initiation. The presence of monomers having a functionality to polymerisation greater than 1 will lead to the formation of a cross-linked network, the rate of crosslinking and the formation of gel being related to the presence of di, tri, tetra and penta functional monomers, the greater the concentration of these higher monomers present the faster the rate of crosslinking and gelation. Although controlling the time at which the cross-linked network is created provides a record of the temperature when the network is created, the created sensing material 20 will also be sensitive to the temperature at which its capacitance is measured (in a similar manner to the response of the liquid crystalline material shown in FIG. 1). For this reason, when attempting to retrieve a recorded temperature from the temperature recorder, it may be necessary to correct the measured temperature (which is equivalent to a measured capacitance) for the effects of the temperature at which the capacitance measurement is made. This may be achieved by providing the capacitance measuring device with a thermometer and a look-up table or algorithm which enables the capacitance measuring device to be adjust the measured capacitance (and hence the measured temperature) for the temperature at which the measurement of the capacitance is made. The capacitance measuring device may then produce a corrected measurement of the temperature which was recorded by the temperature sensor.

The graph shown in FIG. 4 shows the variation in measured capacitance of a temperature sensor according to the present invention as a function of both the temperature at which the cross-linked network is created and as a function of the frequency of the oscillating signal (e.g. alternating current (AC)) used by the capacitance measuring device to measure the capacitance of the temperature recorder. Four sensing cells were created using a reactant mixture comprising 98.98% by weight of KC-FLC10 (liquid crystalline material), 1% by weight of RM-257 (reactive monomer) and 0.02% by weight of BME (photo initiator). The spacing between the electrodes of each sensing cell (and hence the thickness of the reactant mixture and resultant sensing material) was about 5 μm. A UV radiation source was used to trigger the initiation of the cross-linking of the reactive monomer. The initiation was triggered whilst each sensing cell was at a different temperature. These temperatures were 90° C., 75° C., 50° C. and 25° C. The capacitance of each temperature recorder was then measured at a temperature of 30° C. using an Agilent E4980A impedance analyser having an oscillating measurement voltage of 50 mV_{RMS}. It can be seen that the difference between the measured capacitances of the temperature recorders which have been cross-linked at different temperatures is greatest at lower measuring signal frequencies and diminishes at higher frequencies. For this reason, in order to enable differentiation between the measured capacitances of temperature recorders which have recorded different temperatures, it may be preferable to measure the capacitances at relatively low frequencies- E.g. below about 1 MHz, preferably below 10000 Hz, preferably below about 5000 Hz, more preferably below about 3000 Hz and further preferably below about 1000 Hz. The divergence of the capacitances of recorders according to the present invention (which have undergone the cross linking process at different temperatures) as a function of measuring frequency is dependant in part on the relaxation frequency of the liquid crystalline material of the sensing material concerned. In general, the greater the relaxation frequency of the liquid crystalline material, the greater the measurement frequency up to which significant divergence in the capacitances of recorders which have undergone the cross linking process at different temperatures will be observed.

Although the capacitances measured in the previously described embodiments of the invention were measured using an impedance analyser, it may be possible to measure the capacitance of a temperature recorder according to the present invention using alternative methods. This may be beneficial because the use of an impedance analyser to measure the capacitance may be costly and inconvenient. One such alternative is the sensing circuit shown in FIG. 5. The sensing cell 10 may form part of a resistance and capacitance (RC) network. A resistor 22 is linked at one end to one of the electrodes 14 of the sensing cell 10. The other electrode 14 of the sensing cell 10 is connected to ground 24. A voltage generator 26 is connected to the end of the resistor 22 that is not connected to the sensing cell 10. The capacitance of the sensing cell 10 may be measured by using the voltage generator 26 to apply a voltage to the circuit (relative to ground 24) and then measuring the voltage across the sensing cell 10 by connecting a voltage measuring device 28 around the sensing cell (i.e. the voltage measuring device 28 is connected at one end between the resistor 22 and the sensing cell 10, and at the other end to ground 24). The voltage measuring device may have a high input impedance. When a step increase or decrease in voltage is applied to the circuit, the capacitance of the sensing cell 10 causes the measured voltage across the sensing cell 10 to increase or decrease over a characteristic time period (the greater the capacitance of the sensing cell 10, the greater the length of the characteristic time period). The increase or decrease in the measured voltage across the sensing cell 10 occurs as the capacitor is electrically charged or discharged. The relationship between the measured voltage Vₒᵤₜ and the capacitance C of the sensing cell 10 for a step decrease from an applied voltage of Vᵢₙ to zero applied voltage is approximated by:

$${V}_{out} = {V}_{in} {e}^{\frac{- t}{RC}} \qquad ( 1 )$$

where Vᵢₙ is the applied voltage, R is the resistance of the resistor 22 and t is time elapsed since the step decrease in applied voltage. The characteristic time period for electrically charging or discharging a capacitor is given by 1/(RC) and is commonly known as the RC time constant.

It will be appreciated that the response Vₒᵤₜ of the circuit in FIG. 6 will be characterised (at least in part) by the capacitance of the sensing cell 10 for a variety of waveforms of applied voltage (i.e. not just a step increase or decrease in applied voltage). For example, the applied voltage may be an oscillating waveform. Thus a variety of waveforms of applied voltage may be used to measure the capacitance C of the sensing cell 10 and hence the temperature at which cross linking of the reactant mixture occurred.

It will also be appreciated that any appropriate method may be used to measure the capacitance of the sensing cell 10. This may include the use of resonant circuits, alternative RC networks to that described above, or bridge circuits. If an oscillating voltage is used to measure the capacitance of the sensing cell 10, the frequency is preferably constant and is preferably below approximately 5000 Hz as previously discussed in relation to FIG. 4. Also, as discussed above, many different measurement waveforms can be used, for example a pulse (as described in the example above) or an oscillating signal with a DC offset. In addition, a series of pulses may be used. Pulsed signals may also be modulated by an appropriate frequency or may be unmodulated.

Although the described embodiment of the invention measures the capacitance of the sensing cell so as to determine the temperature of the sensing cell when the cross linking process occurred, it will be appreciated that any suitable electric property of the sensing cell may be measured in order to determine the temperature of the sensing cell when the cross linking process occurred. For example, the conductance of the sensing material may be measured.

Although the substrates 12 used within the described embodiment are glass and the electrodes 14 are made out of ITO, this need not be the case. In the described embodiments, the use of glass and ITO, because of their transparency, enables UV radiation to pass from the UV radiation source (to the exterior of the sensing cell) to the reactant mixture. For other embodiments, for example those where cross-linking of the reactant monomer is not initiated by radiation, the substrates and electrodes need not be transparent to radiation.

Alignment layers 16 within the described embodiments are used because increasing the alignment of the liquid crystalline material within the sensing material 20 has been found to increase the difference between the measured capacitance of the sensor at different temperatures. This has the effect of increasing the resolution of the sensor for a given sensitivity of electrical property measuring device. However, a high degree of alignment of the liquid crystalline material may not be necessary in all embodiments of the invention and hence, in certain embodiments, alignment layers may not be necessary.

The thickness of the sensing material 20 within the described embodiments is 5 microns. The thickness of the sensing material 20 may be controlled by the thickness of the spacers 18. It will be appreciated that the sensing material 20 may be of any appropriate thickness. This may be between 0.1 microns and 100 microns and is preferably between 0.5 microns and 10 microns. The capacitance of the sensor is approximately inversely proportional to the thickness of the sensing material for the sensing cell geometry shown in FIG. 2.

Although specific examples of the polar liquid crystalline material and reactive monomer have been used, it will be appreciated that any appropriate polar liquid crystalline material and/or reactive monomer may be used. The reactive monomer should be such that it can be cross-linked to create a cross-linked network which is dispersed within the liquid crystalline material. The reactive monomer is preferably liquid crystalline because this increases the miscibility of the liquid crystalline material of the reactant mixture with the reactive monomer. This is beneficial because this maximises the ability of the reactive monomer to be evenly dispersed within the liquid crystalline material. The even dispersal of the reactive monomer within the liquid crystalline material has the effect that when a cross-linked network is formed, it is largely evenly distributed amongst the liquid crystalline material of the sensing material.

Although the described reactant mixture used to create the sensing material comprises a ferroelectric liquid crystalline material which has a polar phase, this need not be the case. It will be appreciated that any suitable liquid crystalline material may be used within the reactant mixture used to create the sensing material. For example, the liquid crystalline material may not have a polar phase. It will be appreciated that depending on the liquid crystalline material used and the phase of the liquid crystalline material when cross linking occurs, the sensing material formed may have exhibit different temperature dependant electrical properties to those described above. For example, using a particular liquid crystalline material in a particular phase when cross linking occurs, there may be very little dependence of the capacitance of the resulting sensing cell as a function of cross-linking temperature. There may instead be some measurable change in another electrical property of the sensing cell. Furthermore, the relationship between the measured electrical property (capacitance in the described embodiment) of the sensing cell and the cross-linking temperature is substantially linear in relation to the described embodiment. This need not be the case. Depending on the liquid crystalline material used and the phase of the liquid crystalline material when cross linking occurs, the relationship between the measured electrical property of the sensing cell and the cross-linking temperature may be non-linear. It will be appreciated that it is within the scope of the invention for there to be any relationship between the measured electrical property of the sensing cell and the cross-linking temperature provided it is possible to determine what the cross-linking temperature is from the measured electric property of the sensing cell.

The quantitative values of the measurements of the capacitance of temperature recorders according to the present invention will be affected not only by the frequency of measurement signal, but also by the geometry of the sensor, for example the area of the contact plates and the thickness of liquid crystalline material between them. However, the qualitative relationship of the capacitance of the temperature recorder as a function of the cross-linking temperature will remain the same.

Although the described embodiments comprise electrodes which are parallel planar layers, any form of electrode may be used. The electrodes may be any pair of spaced formations which contact the sensing material. For example, the electrodes may be a pair of pins, a pin and a plate or plates of any shape or orientation. Furthermore, although the described embodiment comprises a thickness of sensing material sandwiched between a pair of planar electrodes, it will be appreciated that a recorder geometry may be used whereby both electrodes lie in substantially the same plane. One such arrangement may include interdigitated plate electrodes.

It will be appreciated that, due to the fact that the described sensing cell forms a capacitor, it is not essential for the sensing material to be in direct electrical contact with the electrically conductive electrodes. For example, in the described embodiment, there is a relatively electrically non-conducting alignment layer between the electrode and the sensing material. However, in some embodiments of the present invention it may be preferable for the sensing material to be in direct electrical contact with the electrically conductive electrodes. In other embodiments of the invention the alignment layer may be replaced or supplemented by a layer formed from another material. The alignment layer and/or layer formed from another material may have any appropriate thickness. It will be appreciated that the greater the thickness of the alignment layer and/or layer formed from another material, the less the proportion of the space between the electrodes will be occupied by the sensing material. Because of this, the greater the thickness of the alignment layer and/or layer formed from another material, the less any measured capacitance of the sensing cell will be affected by (and hence representative of) the properties of the sensing material and hence the temperature at which the cross linking process of the sensing material occurred.

It will be appreciated that the temperature recorder may be constructed in a variety of ways. However, one way of particular interest is via the use of ink-jet technology. Accordingly, in a further aspect of the invention there is provided a method of making a temperature recorder as described above, comprising depositing the reactant mixture comprising a liquid crystalline material, a reactive monomer, and optionally an initiator, onto a substrate by inkjet. The substrate may be for example an electrode. Use of inkjet allows the deposition of small and precise amounts of the reactant mixture and is particularly suitable for manufacture of small-scale temperature recorders comprising a plurality of sensing cells. Inkjet technology is well-known in the art and usually comprises ejection of one or more droplets of liquid from a reservoir through a nozzle onto a substrate. Examples of ink-jet technologies include continuous inkjet, thermal inkjet and piezoelectric inkjet.

The temperature recorders of the invention may find utility in many different fields. One application of interest is monitoring the temperature of goods in transit, e.g. as described in WO2008/087396. The temperatures at which perishable goods such as flowers or vegetables are stored during transit may have a significant impact on shelf-life after reaching their destination. Thus recording the temperature during transit may allow more appropriate distribution of goods on arrival at their destination. The temperature recorder of the invention comprising a plurality of sensing cells may be configured so that the cross linking of each cell is initiated at a different time during transit, to produce a ‘history’ of the temperature the goods have been exposed to, as described above. The temperature recorder may be read at the point of destination, e.g. via a passive RFID device, or it may be linked to an active RFID device so that the temperature may be read in real-time. If linked to an active RFID tag the location of the goods may also be monitored whilst in transit.

What is claimed is:

1. A temperature recorder comprising a sensing cell which comprises:
a reactant mixture, the reactant mixture comprising:
a liquid crystalline material,
a reactive monomer, and
an initiator configured to initiate cross-linking of the reactive monomer and thereby form a sensing material which provides a record of the temperature of the sensing cell when cross-linking occurs; the sensing material comprising a cross-linked network dispersed within the liquid crystalline material, the cross-linked network being formed from the reactive monomer;
wherein the sensing cell additionally comprises first and second electrically conductive electrodes having a spaced relationship therebetween and being connectable to an electric property measuring device arranged to measure an electric property of the sensing material.

2. A temperature recorder according to claim 1, wherein the sensing material comprises a continuous phase of liquid crystalline material and wherein the cross-linked network forms a distributed network amongst the liquid crystalline material.

3. A temperature recorder according to claim 1, wherein the liquid crystalline material is polar.

4. A temperature recorder according to claim 3, wherein the polar liquid crystalline material is a ferroelectric or ferrielectric material.

5. A temperature recorder according to claim 1, wherein the first and the second electrically conductive electrodes are configured to produce an electric field within the sensing material when connected to an electric property measuring device.

6. A temperature recorder according to claim 5, wherein the electric property measuring device is a capacitance measuring device arranged to measure the capacitance of the sensing cell.

7. A temperature recorder according to claim 6, wherein the capacitance measuring device is configured to produce an oscillating electric measuring signal.

8. A temperature recorder according to claim 7, wherein the measuring signal has a frequency of less than about 5000 Hz.

9. A temperature recorder according to claim 6, wherein the capacitance measuring device is configured to measure the RC time constant for electrically charging and/or discharging the sensing cell.

10. A temperature recorder according to claim 1, wherein the electrical property measuring device comprises a temperature measuring device configured to measure the temperature of the environment in which the electrical property measuring device is operating.

11. A temperature recorder according to claim 10, wherein the electrical property measuring device is configured to provide an output which is a function of both the measured electric property of the sensing cell and the temperature of the environment in which the electrical property measuring device is operating.

12. A temperature recorder according to claim 1, wherein the initiator comprises a chemical component within the reactant mixture and further comprises an energy source.

13. A temperature recorder according to claim 12, wherein the chemical component comprises a photo initiator and the energy source is a radiation source.

14. A temperature recorder according to claim 1, wherein the initiator is triggered by a substance which is present in air.

15. A temperature recorder according to claim 1, wherein the temperature recorder comprises a plurality of similar independent sensing cells, the initiation of cross-linking in each sensing cell to form a sensing material being independent of another sensing cell.

16. A method of recording temperature at a first time using a temperature sensor according to claim 1, the method comprising:
cross-linking the reactive monomer at the first time to thereby form the sensing material, the cross-linking being initiated by triggering the initiator;
measuring the electric property of the sensing material with an electrical property measuring device connected to the first and the second electrodes at a second time, the second time being after the first time; and
providing an output which is representative of the temperature of the sensing cell at the first time.

17. A method of recording temperature according to claim 16 additionally comprising:
using a temperature measuring device to measure the temperature of the environment in which the electrical property measuring device is operating at the second time; and correcting the output as a function of the measured temperature of the environment in which the electrical property measuring device is operating.

18. A temperature recorder comprising a sensing cell which comprises a sensing material which is produced by:
mixing a liquid crystalline material and a reactive monomer; and
initiating cross-linking of the reactive monomer, to thereby form a cross-linked network dispersed within the liquid crystalline material, the cross-linked network being formed from the reactive monomer.

19. A method of making a temperature recorder according to claim 1, comprising depositing the reactant mixture comprising a liquid crystalline material, a reactive monomer, and optionally an initiator, onto a substrate by inkjet.
